(19) United States
(12) Patent Application Publication
(10) Pub. No.: US 2004/0213296 A1
(43) Pub. Date: Oct. 28, 2004

(54) Data processing method and data processing apparatus

(76) Inventors: Yasutaka Kanayama, Chofu (JP); Teruyuki Sato, Tama (JP)

Correspondence Address: KATTEN MUCHIN ZAVIS ROSENMAN, 575 MADISON AVENUE, NEW YORK, NY, 10022-2585, US

(21) Appl. No.: 10/808,890

(22) Filed: Mar. 25, 2004

(30) Foreign Application Priority Data
Apr. 22, 2003 (JP) 2003-117209

(51) Int. Cl. H04J 3/04

(52) U.S. Cl. 370/535

(57) ABSTRACT

A CODEC which is supporting both a TFO operation and tandem operation includes a homing signal to reset an encoding section and a CODEC for decoding the compressed code data output from the encoding section 5A is transmitted when the TFO condition is shifted to the tandem connecting condition. Also a signal noise alleviation processing section detects a frame synchronization bit and performs a signal noise alleviation process from the leading area of the encoding processing frame and outputs the result to the encoding section.

### FIELD OF THE INVENTION

An audio signal encoding and decoding device (CODEC; Coder/Decoder) is provided for encoding and decoding an audio signal or converting encoded data into other encoded data, in a mobile phone, a terminal, a base station, or an exchange or the like in a mobile communication network.

### DESCRIPTION OF THE RELATED ART

Audio signal encoding (compressing) technology has been widely introduced through the practical application of a digital mobile communication system. In the wireless sections of a mobile communication system, an audio signal is encoded or compressed and then transmitted at a lower bit rate in order to effectively use the wavelength bandwidth. For example, a signal based on code excited linear prediction (CELP) system of about 4 kbps may be used in the wireless sections.

In a public line network, a pulse code modulation (PCM) system of 64 kbps may be utilized for the audio encoded data for transmitting the audio signal. PCM is the encoding system specified on the basis of the G.711 recommendation of ITU-T and the PCM data is the signal having a bit rate of 64 kbps formed by sampling the analog signal of 300 Hz to 3.4 kHz at the frequency of 8 kHz. In view of encoding and decoding the audio signal or converting encoded data into other encoded data, a terminal, a base station, or an exchange in a mobile phone or the like in the mobile communication network is provided with a CODEC; Coder/Decoder.

FIGS. 10(a) and 10(b) illustrate a constitution for communication between mobile terminals based on the prior art. In FIG. 10(a), the audio signal input to a terminal 15A is encoded to compressed code data by a CODEC (not illustrated) in terminal 15A and is then propagated to a base station 11A through wireless transmission. The compressed code data is transmitted to an exchange 12A through the transmission line 14A from the base station 11A and is decoded by the CODEC 13A in the exchange 12A and is encoded to the PCM data.

The PCM data output from the CODEC 13A is transmitted to the exchange 12B through the transmission line 14B and is then encoded to the compressed code data by the CODEC 13B within the exchange 12B. The compressed code data output from the CODEC 13B is transmitted to the base station 11B through the transmission line 14C, propagated to the terminal 15B through wireless transmission, decoded by the CODEC (not illustrated) within the terminal 15B, and is then output as the audio signal.

The audio signal is transmitted to the terminal 15B from the terminal 15A with the processes described above. However, in regard to the encoding of the audio signal in the processing sequence, the compressed code data output from the CODEC within the terminal 15A and output as the audio signal by the CODEC within the terminal 15B goes through the encoding and decoding processes by CODEC 13A and CODEC 13B. As described above, the operating method for repeating the CODEC process for several times is called the cascade-connecting (tandem connecting) operation of the CODEC.

The CELP encoding system or the like for outputting the compressed code data at a lower bit rate realizes a high compression ratio with a method for predicting the current signal from the past audio signal by utilizing the statistic property of voice and then encoding the prediction difference of the audio signal. When voice is encoded and compressed into audio encoded data of a low bit rate, certain amounts of distortion and delay are added to the original audio signal.

In the case of audio encoded data of a higher bit rate such as PCM data or the like having the bit rate of 64 kbps, deterioration of sound quality and delay due to the continuous encoding in tandem connecting CODECs is rather small. However the influence of the deterioration in sound quality and delay due to the continuous encoding in tandem connecting CODECS is large in audio encoded data of a lower bit rate which may be used in a mobile communication system.

FIG. 10(b) is a schematic diagram of audio encoded data of a certain audio signal input to terminal 15A and output for transmission to terminal 15B. The compressed code data 20A is the compressed code data encoded and compressed by the CODEC within terminal 15A, while the PCM data 21A is the PCM data conforming to the G.711 standard expanded and decoded in CODEC 13A and the compressed code data 20B is the compressed code data encoded and compressed in CODEC 13B.

The audio signal output from terminal 15B can be formed by decoding the compressed code data 20B by the CODEC in terminal 15B. However, since the compressed code data 20B is formed by encoding the compressed code data 20A by the CODECs 13A and 13B and the compressed code data 20A is the encoded data of a low bit rate and high compression ratio which generates deterioration of sound quality and delay due to the tandem connection of the CODECs, an audio output of terminal 15B formed by decoding the compressed code data 20B includes more deterioration of sound quality and further delay than the audio signal input to terminal 15A.

As described above, the tandem connection of CODECs results in some problems for transmission of the compressed code data of a lower bit rate. However the prior art describes some methods for avoiding such a tandem connection of CODECs, for example patent document U.S. Pat. No. 5,991,716 described a method which is called tandem free operation and (TFO) standardized by TS28.062 of the 3^{rd} generation partnership project (3GPPTS28.062 V 3.0 2002-03) are well known.

As described in U.S. Pat. No. 5,991,716, in TFO communication, both CODECs (13A & 13B) carry out the normal coding operations for the speech by decoding it in one CODEC into normal digital pulse code modulated (PCM) speech samples which are forwarded to the second CODEC and encoded therein by the speech coding method. In addition there is simultaneously transferred speech information which is in accordance with the speech coding method and received from the mobile station, i.e. speech parameters for which no coding operations (encoding and decoding) are carried out in either of the tandem connected CODECs. This is added to the two least significant bits of the PCM samples. The receiving CODEC primarily chooses the speech information that is in accordance with this speech encoding method to be transmitted over the wireless transmission to the receiving mobile station. Consequently, speech coding is carried out primarily in the mobile stations only, and the coded speech information, i.e. speech parameters, are passed through the mobile communication network without tandem coding, which improves speech quality. When the receiving CODEC cannot find the coded speech information in the least significant bits of the PCM speech samples, the speech information to be transmitted over the radio interface is encoded in the normal manner from the PCM speech samples. Accordingly, the tandem connection of the CODECs can be avoided.

FIGS. 11(a), 11(b) illustrate a constitution for communication between mobile terminals through CODEC 13A and CODEC 13B in the TFO condition. In the accompanying drawings of the present invention, the CODECs in the TFO condition are indicated as the shaded ones such as the CODECs 13A and 13B of FIGS. 11(a) and 11(b).

In FIG. 11(a), an audio signal input to terminal 15A is encoded to compressed code data by a CODEC (not illustrated) within terminal 15A, propagated to the base station 11A through wireless transmission and is input to the exchange 12A through the transmission line 14A.

The CODEC 13A in the TFO condition assigns a part of the PCM data formed by decoding the compressed code data input to the exchange 12A as the TFO frame, stores the compressed code data input into the TFO frame and outputs the PCM data including the TFO frame.

The PCM data including the TFO frame is then input to the exchange 12B via the transmission line 14B. The CODEC 13B in the TFO condition outputs the compressed code data stored in the TFO frame extracted from the PCM data including the TFO frame. The compressed code data output from the CODEC 13B is transmitted to the base station 11B through the transmission line 14C, propagated to the terminal 15B through wireless transmission, decoded with the CODEC (not illustrated) within terminal 15B, and output as the audio signal.

FIG. 11(b) illustrates the audio signal and encoded data in TFO communication. The audio signal output from terminal 15B can be formed by decoding the compressed code data 20C by the CODEC in terminal 15B, but the compressed code data 20C is extracted from the TFO frame included in the PCM data 21B and is identical to the compressed code data 20A encoded by the CODEC within terminal 15A. Accordingly, since the audio signal output from terminal 15B is formed by decoding the audio signal encoded by the CODEC in terminal 15A by without any intermediate encoding and decoding processes, the audio signal has a smaller amount of deterioration in sound quality and delay in comparison with the signal in the tandem connection operation of the CODEC.

FIG. 12(a) illustrates the PCM data including the TFO frame. The Format of the PCM signal including the TFO frame is specified with the TS28.062 standard and communication between the CODECs in the TFO condition can be realized using the PCM data of this format. As illustrated in FIG. 12(a), the PCM data transmitted under the TFO condition has the format where the most significant six bits (MSB six bits) are formed of the most significant six bits of the PCM signal formed by the decoding process in the CODEC, while the least significant two bits (LSB two bits) are formed of the TFO frame and TFO message.

In FIG. 12(a), the TFO frame is indicated as the shaded area, while the TFO message is indicated as the heavier shaded area. The TFO message is used as a means for negotiation with the exchange or base station of the opposite side and the least significant one bit is used in every 16 samples of the PCM data. Moreover, the TFO frame is the region for actually carrying the compressed code data. Data such as the encoded data is stored to this TFO frame.

FIG. 12(b) illustrates a sample including the TFO message among the PCM data including the TFO frame. The most significant six bits (MSB six bits) are formed of the PCM data, the least significant one bit (LSB one bit) is formed of the TFO message, and the first bit of the least significant two bits is formed of the TFO frame. Since the TFO message exists in every 16 samples of the PCM data including the TFO frame, the sample illustrated in FIG. 12(b) exists in every 16 samples in the PCM data illustrated in FIG. 12(a).

FIG. 12(c) illustrates a sample not including the TFO message among PCM data including the TFO frame. The most significant six bits (MSB six bits) are formed of the PCM data and the least significant two bits (LSB two bits) are formed of the TFO frame. The sample illustrated in FIG. 12(c) exists continuously in 15 samples of the PCM data illustrated in FIG. 12(a).

The CODEC supporting TFO has the function for automatic switching to the TFO condition from the non-TFO condition when the TFO frame is detected from the PCM data and the function for automatic switching to the non-TFO condition from the TFO condition when it is detected that the TFO frame disappears from the PCM data. In the TFO condition, the encoded data of the CODEC in terminal 15A is transmitted to the exchange or base station in the opposite side, but only the LSB two bits of the 64 kbps formed by the ordinary expanding process are assigned to the TFO frame and TFO message.

Namely, since the compressed code data is not transmitted in place of the PCM data and both PCM data and compressed code data are transmitted through the multiplexing in the TFO, if the TFO condition disappears because of a certain reason, the communication can be continued by switching the operating condition to the tandem connection.

It is an ideal condition for a TFO supporting CODEC that the existence of a TFO frame within the received PCM data is synchronized with the switching operation between the TFO and tandem connection. However, in the actual operating conditions the ideal is not always present. A condition may also be generated where TFO does not occur (tandem connecting condition appears) when the PCM data including the TFO frame is transmitted or that the tandem connecting condition does not occur (TFO condition appears) when PCM data not including the TFO frame is transmitted.

With regard to the situation in which TFO does not occur when the PCM data including the TFO frame is transmitted, the following cases may be listed: (1) the normal TFO frame cannot be detected due to the mixture of error into the TFO frame or displacement of the error check mechanism and thereby the operating condition does not shift to the TFO, (2) an error occurs in the negotiation based on the TFO message and thereby the non-interchangeable TFO frame is transmitted and the operating condition cannot be shifted to the TFO condition, and (3) hand-over (hereinafter referred to as local hand-over) occurs in the receiving station side and thereby the PCM data including the TFO frame is transmitted simultaneously with commencement of a call. According to the 3GPP TS28.062 standard, transition to TFO is impossible, if negotiation between the CODECs is not performed. When the local hand-over occurs and the PCM data including the TFO frame is transmitted simultaneously with commencement of the call like case (3), the PCM data including the TFO frame is transmitted to the CODEC of the receiving station which is not in the TFO condition.

As the situation wherein the tandem connecting condition disappears when the PCM data not including the TFO frame is transmitted, the following case (4) may be listed, in which the hand-over in the transmitting station side (hereinafter referred to as remote hand-over) occurs and the TFO frame included in the PCM data disappears simultaneously with commencement of the call.

FIGS. 2(a) to 2(c) illustrates a constitution of communication between the mobile terminals through the CODEC in the TFO condition. This constitution schematically illustrates the communication devices and audio encoded data before and after occurrence of the local hand-over.

In TFO communication before a local hand-over is generated as illustrated in the upper part of FIG. 2(b), the audio signal input to the terminal 15A is encoded, as in the case of TFO communication illustrated in FIG. 11(a), to the compressed code data by the CODEC (not illustrated) in terminal 15A, propagated to the base station 11A through wireless transmission, input to the exchange 12A, and is then output after the encoding to PCM data including the TFO frame by the CODEC 13A in the TFO condition. The PCM data including the TFO frame output from the CODEC 13A is then input to the exchange 12B and the compressed code data stored in the TFO frame is extracted by the CODEC 13B in the TFO condition, transmitted to the base station 11B, propagated to terminal 15B through wireless transmission, decoded by the CODEC (not illustrated) in terminal 15B, and output as the audio signal.

FIG. 2(a) schematically illustrates the audio signal and encoded data of communication before generation of a local hand-over. The audio signal output from terminal 15B has been obtained by decoding the audio signal encoded by the CODEC in terminal 15A without any intermediate coding and decoding processes and thereby an audio signal with less deterioration of sound quality and delay, in comparison with the signal under the tandem connection of the CODEC, can be obtained.

The arrow mark indicating the lower direction in FIG. 2(b) shows the local hand-over in which the base station of terminal 15B is handed over to the base station 11C from the base station 11B due to the movement or the like of terminal 15B and the PCM data including the TFO frame is transmitted to the CODEC 13C in the exchange 12C simultaneously with commencement of a call. Under the local hand-over condition, the CODEC 13C receives the PCM data including the TFO frame. However, according to the TS28.062 standard, if negotiation between the CODECs is not performed, the CODEC cannot shift to the TFO condition and therefore the CODEC 13C is set to the tandem connecting condition. Therefore, the CODEC 13C in the tandem connecting condition, receives the PCM data including the TFO frame output from the CODEC 13A in the TFO condition.

The PCM data including the TFO frame output from the CODEC 13A is input to the exchange 12C and is encoded to the compressed code data by CODEC 13C. The compressed code data output from CODEC 13C is transmitted to the base station 11C, propagated to terminal 15B through wireless transmission, decoded by the CODEC (not illustrated) in terminal 15B and is then output as the audio signal.

FIG. 2(c) schematically illustrates the audio signal and encoded data of TFO communication after the local hand-over is generated. The audio signal output from terminal 15B is formed by decoding the compressed code data 20E and the compressed code data 20E has been formed by encoding the PCM data 21C including the TFO frame by CODEC 13C not in the TFO condition. Only the most significant six bits (MSB six bits) among the PCM data 21C including the TFO frame include original data of, as illustrated in FIG. 12, the encoded audio signal input to terminal 15A and the lesser two bits (TFO frame portion) are data of signal noise which is not related to the original sound in the PCM encoding system.

Namely, the audio signal output from terminal 15B is formed by encoding the signal input to the terminal 15A, multiplexing the most significant six bits of the PCM data encoded by the CODEC 13A in the TFO condition and least significant two bits of data not related to the PCM data, encoding the multiplexed signal to the compressed code data in CODEC 13C, which is not in the TFO condition and decoding the compressed code data in terminal 15B.

Accordingly, since the audio signal obtained in terminal 15B with the processes described above is encoded and decoded with CODECs 13A and 13C, this signal includes deterioration of sound quality and delay due to the tandem connection of the CODECs. In addition, since the data transmitted as the PCM data from CODEC 13A includes the TFO frame and is received and encoded as an ordinary PCM signal not including the TFO frame in the CODEC 13C, this data becomes an audio signal including signal noise generated by the multiplexing of the PCM & TFO frames.

FIGS. 3(a), 3(b) and 3(c) illustrate a constitution of communication between mobile terminals through the CODEC in the TFO condition. These figures schematically illustrate the communication devices and audio encoded data.

In TFO communication before generation of remote hand-over illustrated in the upper side of FIG. 3(b), the audio signal input to terminal 15A is encoded, as in the case of TFO communication illustrated in FIG. 11(a), to the compressed code data by the CODEC (not illustrated) in terminal 15A, propagated to the base station 11A through wireless transmission, input to the exchange 12A, and output as the PCM data including the TFO frame from CODEC 13A. The PCM data including the TFO frame output from CODEC 13A is input to the exchange 12B, output as the compressed code data stored in the TFO frame from CODEC 13B, transmitted to the base station 11B, propagated to terminal 15B through wireless transmission, and decoded and output as the audio signal from the CODEC (not illustrated) in terminal 15B.

FIG. 3(a) schematically illustrates the audio signal and encoded data of TFO communication before generation of remote hand-over. As in the case of the audio signal and encoded data of the TFO illustrated in FIG. 11(b), the audio signal output from terminal 15B can be formed by decoding the audio signal encoded by the CODEC in terminal 15A without any intermediate encoding and decoding processes and an audio signal with a smaller amount of deterioration of sound quality and delay, in comparison with the signal under the tandem connection of CODEC, can be obtained.

The arrow indicating the lower direction in FIG. 3(b) indicates the remote hand-over in which the base station of terminal 15A is handed over to the base station 11C from the base station 11A due to the movement of terminal 15A. According to the TS28.062 standard, transition to the TFO condition does not occur if negotiation between the CODECs is not executed. Therefore, CODEC 13C is in the tandem connecting condition. Accordingly, CODEC 13C following the remote hand-over transmits the PCM data not including the TFO frame and thereby CODEC 13B in the TFO condition receives the PCM data not including the TFO frame.

When the CODEC in the TFO condition has received the PCM data not including the TFO frame, a “frame-loss” error (TFO error) disabling detection of the TFO frame occurs. If CODEC 13B is in the frame-loss condition, the audio signal output from terminal 15B through the decoding of the compressed code data output from CODEC 13B changes to a silent signal.

FIG. 3(c) illustrates the audio signal and encoded signal of communication after the remote hand-over is generated. Since the audio signal output from terminal 15B is formed by decoding the compressed code data 20E and the compressed code data 20E is output from CODEC 13B in the error condition, the audio signal output from terminal 15B changes to a silent signal.

In the CODEC which is supporting TFO, when the PCM data not including the TFO frame is continuously input, communication can be recovered through transition to the tandem connection. According to the TS28.062 standard, however, at least 12 frames (0.24 seconds) are required until the CODEC in the TFO condition shifts to the tandem connecting condition after the TFO frame disappears.

Therefore, when the CODEC in the TFO condition receives the PCM data not including the TFO frame due to generation of the remote hand-over, the audio signal output changes to a silent signal for a certain period.

As described above, it is an ideal condition that existence or non-existence of the TFO frame in the PCM data received is synchronized with the switching operation between the TFO and tandem connecting conditions in the CODEC which is supporting the TFO condition. However, in actual operating conditions, the following situations are naturally generated, in which the TFO condition does not occur (tandem connecting condition) when the PCM data including the TFO frame is transmitted, or the tandem connecting condition does not occur (TFO condition) when the PCM data not including the TFO frame is transmitted.

In the situation in which the TFO condition does not occur when the PCM data including the TFO frame is transmitted, for example, when the local hand-over illustrated in FIG. 2 is generated, the PCM data including the TFO frame is converted to the compressed code as the PCM data not including the TFO frame. Accordingly, the audio signal is output which includes a mixing of a certain signal noise due to the TFO frame, in addition to deterioration of sound quality and delay due to the tandem connection.

Moreover, it also possibly occurs that the tandem connecting condition is not generated when the PCM data not including the TFO frame is transmitted, for example, that the output audio signal changes to a silent signal for a certain period under the remote hand-over condition illustrated in FIG. 3.

In addition, the CODEC which is supporting the TFO condition is operated through the switching between the TFO and tandem connecting conditions. However, in the compressed encoding system for outputting the compressed code data of a low bit rate, prediction is performed by utilizing the statistic property of voice. Therefore, noise sound is probably generated due to mismatching of the internal conditions of CODEC for outputting the compressed code data or mismatching of the internal conditions of CODEC for decoding the compressed code data in the timing of the switching operation between the TFO and tandem connecting conditions.

### SUMMARY OF THE INVENTION

A data processing apparatus and method is described, wherein the data processing inputs a first data formed by encoding an analog signal with a first encoding system or a third data multiplexing a second data formed by encoding the analog signal with a second encoding system and the first data and outputs a fourth data encoded with the second encoding system, which is characterized in that a first mode for inputting the first data for encoding with the second encoding system and a second mode for inputting the third data to isolate the second data are comprised, and when the third data is inputted in the first mode, a part of the third data where the second data is multiplexed is replaced with a particular data and this particular data is encoded with the second encoding system.

Accordingly, when the data are processed, signal noise due to the multiplexed part during the encoding of the third data in the second mode with the second encoding system can be lowered when the first mode is switched to the second mode.

Further described is a data processing method and apparatus which inputs a first data formed by encoding analog signal with a first encoding system or a third data multiplexing a second data formed by encoding analog signal with a second encoding system and the first data and outputs a fourth data encoded with the second encoding system, which is characterized in that a first mode for inputting the first data for encoding with the third encoding system and a second mode for inputting the third data for isolation of the second data are comprised, and the data for resetting the data processing apparatus for decoding the data outputted in the second encoding system is outputted through addition to the fourth data before the switching operation when the operation mode is switched to the first mode or second mode.

Accordingly, it is possible to reduce generation of a fault of an output analog signal due to mismatching of internal variables of the data processing apparatus which is generated in the case of decoding of the encoded data outputted during the switching between the first mode and second mode.

Also data transmission system includes a first terminal which outputs a second data formed by encoding analog signal with a second encoding system, a first data terminal which inputs the second data and outputs, in a first mode, a first data encoded with a first encoding system and also outputs, in a second mode, a third data multiplexing the second data and the first data, a second data terminal which inputs the first or third data outputted from the first data terminal and outputs a fifth data formed by encoding the first data inputted with the second encoding system in the first mode and also outputs the second data isolated from the third data inputted in the second mode, and a second terminal which inputs the second or fifth data outputted from the second data terminal and outputs the analog signal, which is characterized in that when said data terminal is in the first mode and the third data is inputted, a part of the third data where the second data is multiplexed is replaced with a particular data and this particular data is outputted through the encoding thereof with the second encoding system.

Accordingly, when the data is processed, signal noise due to the data of the multiplexed part generated by the encoding of the third data with the second encoding system in the second mode can be lowered when the operation mode is switched to the second mode from the first mode.

In a further embodiment a data transmission system includes a first terminal which outputs a second data formed by encoding analog signal with a second encoding system, a first data terminal which inputs the second data and outputs a first data encoded with a first encoding system in the first mode and also outputs a third data multiplexing the second data and the first data in the second mode, and a second data terminal which inputs the first or third data and outputs a fifth data formed by encoding the first data with a second encoding system in the first mode and also outputs the second data isolated from the third data inputted in the second mode, and a second terminal which inputs the second or fifth data outputted from the second data terminal and outputs the analog signal, which is characterized in that the data for resetting the data processing apparatus for decoding the data output in the second encoding system is outputted through addition to the fourth data before the switching operation when the operation mode is switched to the first mode or second mode.

Accordingly, it is possible to reduce generation of a fault of an output analog signal due to mismatching of internal variables of the data processing apparatus which is generated in the case of decoding of the encoded data outputted during the switching operations between the first mode and second mode.

A data processing apparatus according to another embodiment inputs a first data formed by encoding analog signal with a first encoding system or a third data multiplexing a second data formed by encoding the analog signal with a second encoding system and the first data and outputs a fourth data encoded with the second encoding system, which is characterized in comprising a first mode and a second mode, a data input section which outputs whether the input data is the third data or not to an input data determining section and outputs the second data isolated from the third data to an output switching section when the input data is the third data in the second mode, and a signal processing section which inputs the data inputted and outputs the input data to an encoding section, wherein the output switching section outputs an output of the signal processing section in the first mode and also outputs an output of the data input section in the second mode, and the signal processing section replaces a part of the third data where the second data is multiplexed with a particular data and then outputs the particular data to the encoding section.

Accordingly, when the data is processed, signal noise due to the data of the multiplexed portion in the case of the encoding of the third data with the second encoding system in the second mode can be lowered when the first mode is switched to the second mode.

A data processing apparatus in another embodiment inputs a first data formed by encoding analog signal with a first encoding system or a third data multiplexing a second data formed by encoding the analog signal with a second encoding system and the first data and outputs a fourth data encoded with the second encoding system, characterized in comprising a first mode and a second mode, a data input section which outputs whether the input data is the third data or not to an input data determining section, isolates the second data from the third data inputted when the input data is the third data in the second mode, and outputs the isolated second data to an output switching section and a signal processing section which inputs the data inputted and outputs the input data to an encoding section, wherein the output switching section outputs an output of the signal processing section in the first mode and also outputs an output of the data input section in the second mode, and the encoding section outputs, when operation mode is switched to the first mode or second mode, the data for resetting the data processing apparatus for decoding the data outputted in the second encoding system through addition thereof to the fourth data.

In addition the embodiment may include that the input data determining section determines that the third data is inputted by detecting the synchronization bit of the multiplexed data.

The data processing apparatus may also be characterized in that the input data determining section determines that the third data is inputted by detecting the signal to be transmitted before the third data is transmitted.

The data processing apparatus may also be characterized in that the input starting position of the third data determined as input is obtained from the signal to be transmitted before the third data is transmitted.

### BRIEF DESCRIPTION OF THE DRAWINGS

FIG. 1 illustrates an audio signal encoder of the present invention;

FIGS. 2(a), 2(b), 2(c) illustrates local hand-over;

FIGS. 3(a), 3(b), 3(c) illustrates distant hand-over;

FIGS. 4(a), 4(b) illustrates signal noise alleviation process of the PCM signal of the present invention;

FIGS. 5(a), 5(b) illustrates the TFO frame and the encoding processing frame as the signal noise alleviation process object;

FIGS. 6(a), 6(b) illustrates the TFO frame and the encoding processing frame as the signal noise alleviation process object;

FIG. 7 illustrates the signal noise alleviation process determination flow;

FIGS. 8(a), 8(b) illustrates the TFO frame, encoding processing frame and shift to the tandem connecting condition;

FIG. 9 illustrates the TFO determination flow of the audio encoder of the present invention;

FIGS. 10(a), 10(b) illustrates the tandem connecting condition;

FIGS. 11(a), 11(b) illustrates the TFO condition; and

FIGS. 12(a), 12(b), 12(c) illustrates the PCM data including the TFO frame.

### DETAILED DESCRIPTION OF THE PREFERRED EMBODIMENTS

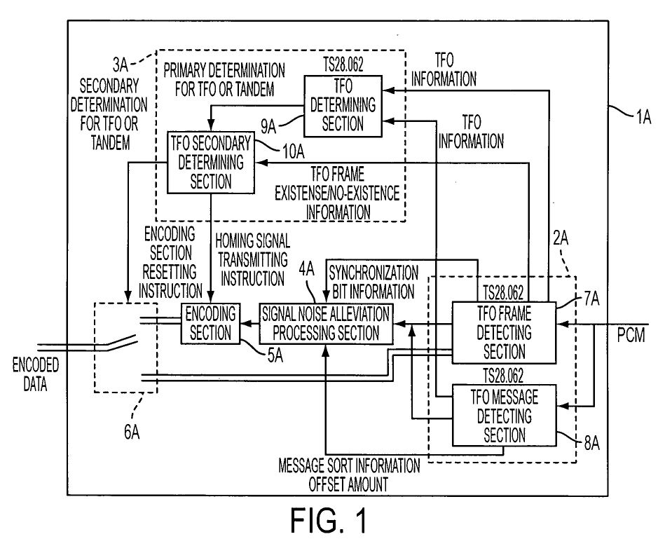

FIG. 1 illustrates a constitution of a data processing apparatus as applied to a voice signal coder/decoder (CODEC) for processing an audio signal which has been encoded as the data processing object. The CODEC 1A can process PCM data including a tandem free operation (TFO) frame. PCM data including a tandem free operation (TFO) frame is multiplexed data formed by multiplexing compressed code data obtained with a first encoding system and pulse code modulation (PCM) data obtained with a second encoding system. The data processing apparatus includes a data input section 2A, an input data determining section 3A, a signal noise alleviation process section 4A as the signal processing section and an encoding section 5A. The data input section 2A includes a TFO frame detecting section 7A and a TFO message detecting section 8A, while the input data determining section 3A includes a TFO determining section 9A and a TFO secondary determining section 10A. The TFO frame detecting section 7A, TFO message detecting section 8A, and TFO determining section 9A satisfy conformance to the TS28.062 of the 3^{rd} generation partnership project(3GPP TS 28.062 V4.3.0 2002-03).

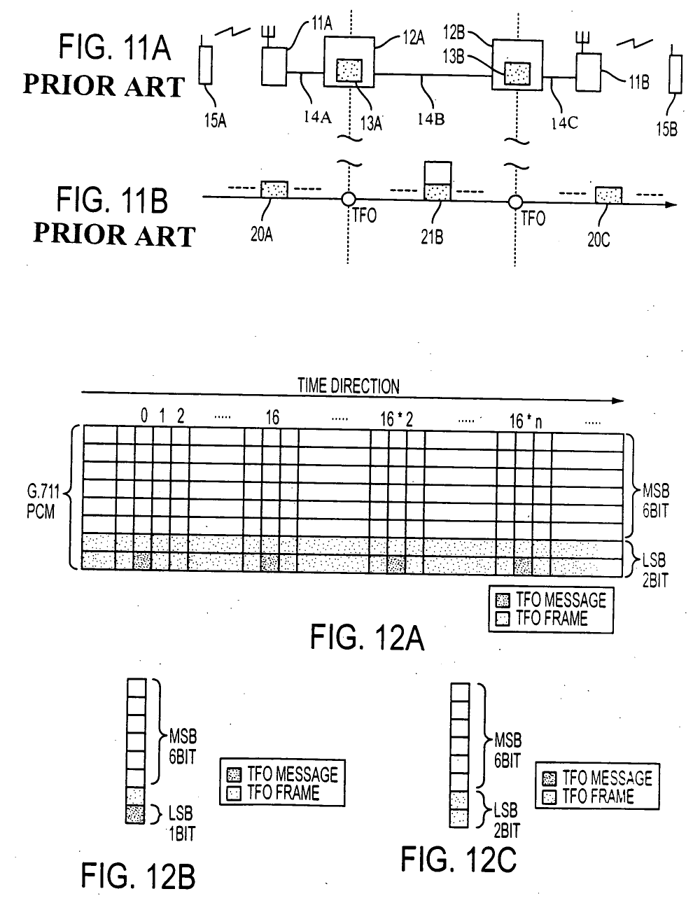

As illustrated in FIGS. 12(a) to 12(c), the PCM data including the TFO frame is formed by multiplexing the PCM data formed by encoding the audio signal and the data formed by encoding the same audio signal with the compression encoding system, and the compressed code data is stored in the least two bits of the PCM data. Moreover, the PCM data including the TFO frame includes, in the lesser one bit, the TFO message in every 16 samples. The TFO message detecting section 8A detects the TFO message included in the input PCM data and outputs the information included in the TFO message to the TFO determining section 9A. Moreover, the TFO frame detecting section 7A detects the TFO frame included in the input PCM data and outputs the information included in the TFO frame to the TFO determining section 9A.

The TFO determining section 9A outputs the determining information for TFO switching (switching between TFO and tandem connection) on the basis of the information output from the TFO frame detecting section 7A and TFO message detecting section 8A.

In a particular embodiment determination for switching of the TFO by the determining section is made on the basis of the information of the TFO frame detecting section 7A and TFO message detecting section 8A depending on the specifications determined on the basis of the TS28.062 standard. TFO switching is never executed only through detection of the existence or no-existence of the TFO frame.

Since the compressed code data has a low bit rate, a bit error of a highly compressed algorithm has a large influence on the sound quality of the output audio signal. Moreover, since the compressed code data is stored in the TFO frame in TFO, a check for various errors is conducted for the TFO frame in the TFO frame detecting section 7A. In the TS28.062 standard, the TFO frame synchronization bit and the CRC code for the encoded data or the like are specified as the error check object. The TFO frame synchronization bit is used to detect the existence of the TFO frame in the PCM data, while the CRC code for the encoded data is used to detect that the encoded data information stored in the TFO frame is normal.

The PCM data input to the audio encoder 1A is input to the TFO frame detecting section 7A and the TFO message detecting section 8A. The TFO frame detecting section 7A detects the existence or no-existence of the TFO frame synchronization bit from the input PCM data, outputs the information about the TFO to the TFO determining section 9A, outputs the information about the existence or no-existence of the TFO frame to the TFO secondary determining section 10A, and also outputs the information about the existence or no-existence of the TFO frame synchronization bit to the signal noise alleviation processing section 4A.

In addition, the TFO frame detecting section 7A extracts the encoded data stored in the TFO frame, verifies the existence or no-existence of an error in the encoded data using the CRC code of the encoded data and outputs a result to the encoded data output switching section 6A. The information about existence or no-existence of an error in the encoded data is output to the TFO determining section 9A.

The TFO message detecting section 8A detects the TFO message from the input PCM data, outputs the TFO information included in the TFO message to the TFO determining section 9A, and outputs the message sort information and offset amount to the signal noise alleviation processing section 4A.

The signal noise alleviation processing section 4A processes and outputs the PCM signal output from the TFO frame detecting section 7A and TFO message detecting section 8A. Since only the most significant six bits of the PCM signal formed by decoding the compressed code data remain as the original PCM data in the PCM data including the TFO frame and TFO message, the signal noise alleviation processing section 4A varies a value of the lesser two bits of the PCM data and outputs this value to the encoding section 5A on the basis of the information input from the TFO frame detecting section 7A and TFO message detecting section 8A.

The TFO secondary determining section 10A switches an input of the encoded data output switching section 6A on the basis of information concerning the existence and no-existence of the TFO frame output from the TFO frame detecting section 7A and the information about determination for switching of TFO output from the TFO determining section 9A and outputs, to the encoding section 5A, an encoder resetting instruction and a transmitting instruction of the homing signal for resetting the remote CODEC.

Operations of each circuit of an embodiment of the audio encoder will be described below.

In FIG. 1, the TFO frame detecting section 7A detects the synchronization bit of the TFO frame included in the input PCM data and outputs the synchronization bit information to the signal noise alleviation processing section 4A.

The signal noise alleviation processing section 4A performs the signal noise alleviation process on the basis of the TFO frame synchronization bit information input from the TFO frame detecting section 7A and the message sort information input from the TFO message detecting section 8A.

First, operations of the signal noise alleviation processing section 4A on the basis of the TFO synchronization bit information detected by the TFO frame detecting section 7A will be described. When the synchronization bit is detected and the PCM data including the TFO frame and TFO message is input, a value of the two least significant bits of the PCM data is varied and in other cases, the PCM data is never varied and this PCM data is output to the encoding section 5A. The two least significant bits of the PCM data take values of four patterns of (0,0), (0,1), (1,0) and (1,1) but since the appearance probability of the four patterns of the PCM data is thought to be statistically identical, an error from the PCM data which is formed by decoding of the compressed code data can be reduced by filling the TFO frame with the value near to the average value of the four patterns.

Whether the signal noise alleviation processing section 4A should perform the signal noise alleviation process or not is determined on the basis of the existence of the TFO frame within the input PCM data. Accordingly, only the synchronization bit information is used among the information obtained with the TFO frame detecting section 7A and error information of the frame is never used.

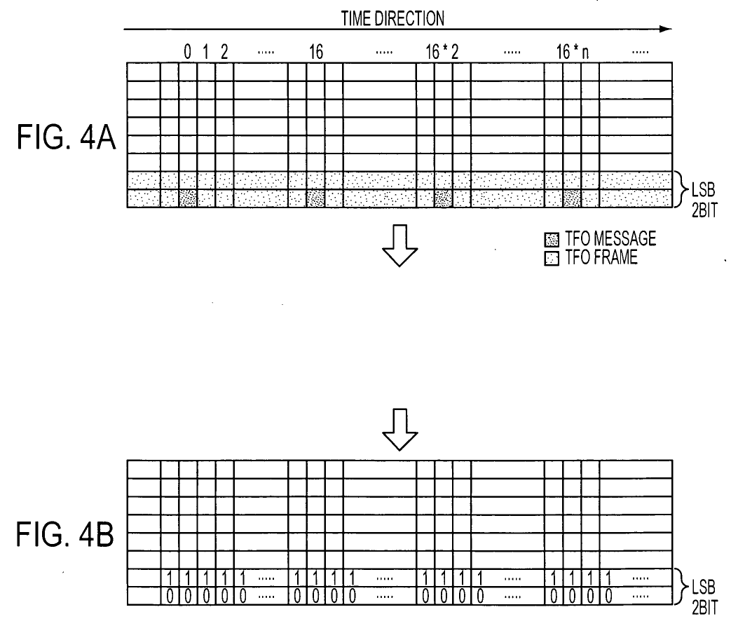

FIGS. 4(a) and 4(b) illustrate an example of the signal noise alleviation process conducted by the signal noise alleviation processing section 4A. The two least significant bits of the PCM data including the TFO frame are filled with the fixed pattern of (1,0) to form the PCM data illustrated in FIG. 4(b). The PCM data with this process corresponds, when the compressed code data is decoded to the PCM data, to the quantization with six bits in place of eight bits. Therefore, PCM data which is more similar to the original sound than the PCM data including the TFO frame can be obtained.

As described above, the situation in which the TFO condition does not occur even when the PCM data including the TFO frame is transmitted can be listed as follows:

(1) The TFO frame cannot be detected as a normal frame due to the mixture of an error into the TFO frame and deviation in the error check mechanism.

(2) The operating condition does not yet shift to the TFO condition because an error is detected in the negotiation using the TFO message and thereby non-compatible TFO frames are transmitted.

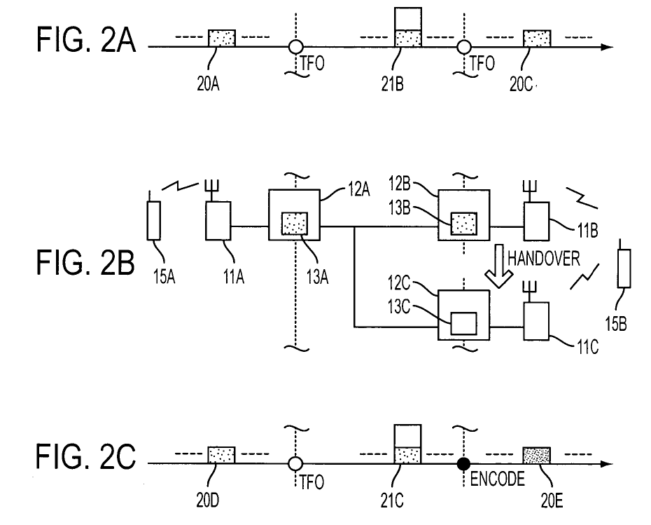

(3) The PCM data including the TFO frame is transmitted simultaneously with commencement of a call when the local hand-over as illustrated in FIG. 2 is generated.

Signal noise of the output audio signal due to existence of the TFO frame can be reduced by executing the signal noise alleviation process to the PCM data including the TFO frame with the CODEC of the present embodiment.

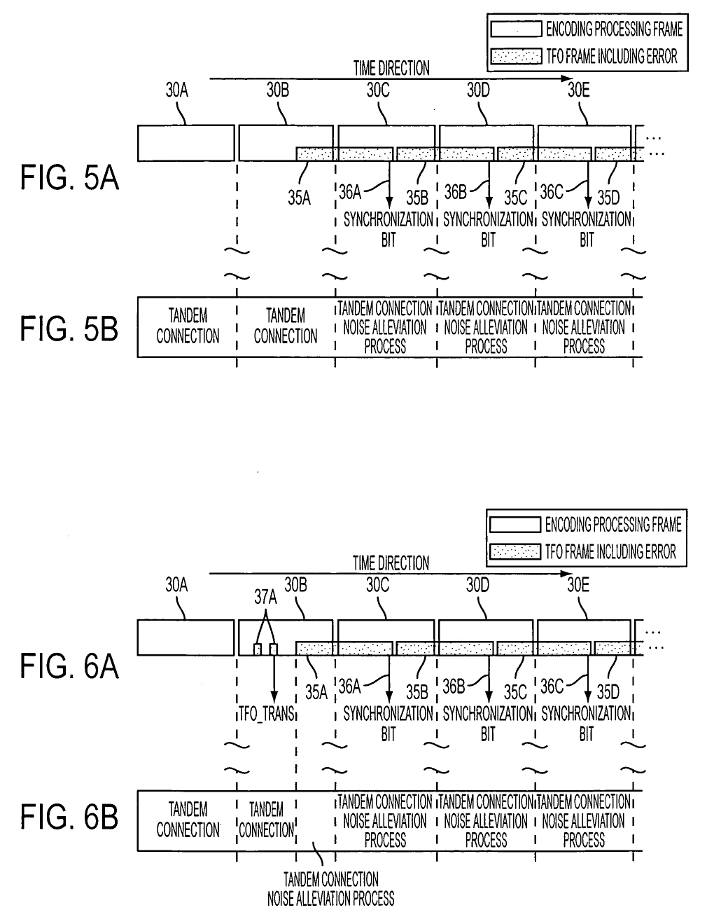

FIGS. 5(a) and 5(b) illustrate transition of the PCM data and operations of a CODEC when PCM data including a TFO frame having an error is input, such as where the normal negotiation is not performed in the PCM data train to be input to the CODEC of the tandem connecting condition (non-TFO condition). In FIG. 5(a), the frames 30A to 30E indicate the encoding process frames as the object of a series of encoding processes with the CODEC, while the frames 35A to 35D indicate the TFO frames and the synchronization bits 36A to 36C indicate the TFO frame synchronization bits of the TFO frames 35A to 35C. In general, the encoding processing frames of the CODEC are never synchronized with the TFO frames and the TFO frame 35A appears in the source of the encoding processing frame 30B in FIG. 5.

When the PCM data train illustrated in FIG. 5(a) is input to a CODEC, the TFO frame detecting section 7A illustrated in FIG. 1 detects the TFO frame synchronization bits 35A to 35C of FIG. 5(a) and transmits these bits to the signal noise alleviation processing section 4A. The signal noise alleviation processing section 4A executes, on the basis of such TFO frame synchronization bits, the signal noise alleviation process for the encoding process frames 30C to 30E to which the TFO frame synchronization bit detecting information is transmitted and then outputs the result to the encoding section 5A.

As illustrated in FIG. 5(b), the CODEC which is usually set in the tandem connecting condition for the encoding frames 30A to 30B is set to the tandem connecting condition to perform the noise signal alleviation process for the subsequent frames of the encoding frame 30C including the TFO frame synchronization bit.

Accordingly, even when the PCM data train including the TFO frame illustrated in FIG. 5(a) is input to the CODEC which is not in the TFO condition, a signal noise alleviation process using the TFO frame can be realized by detecting the synchronization bit of the TFO frame.

In the embodiment described above, the signal noise alleviation processing section 4A has conducted the signal noise alleviation process by determining the existence of the TFO frame through detection of the synchronization bit information obtained from the TFO frame detecting section 7A. However when PCM data including the TFO frame is transmitted to a CODEC not in the TFO condition because the transmitting side CODEC transitioned to the TFO condition from the tandem connecting condition, input of the PCM data including the TFO frame can be detected quicker by detecting the message specified by the TFO standard rather than detection of the TFO frame synchronization bit.

According to the TS28.062 standard, it is specified to transmit the TFO#TRANS message just before transmission of the TFO frame when the tandem connecting condition is shifted to the TFO condition and moreover offset an amount of the TFO frame commencement position and the TFO#TRANS message is also specified. Accordingly, existence of the TFO frame can be detected more accurately by detecting the TFO#TRANS message in place of the TFO frame synchronization bit.

FIG. 6(a) illustrates a PCM data train transmitted when the transmitting side CODEC shifts to the TFO condition from the tandem connecting condition. As in the case of FIG. 5(a), frames 30A to 30E indicate the encoding processing frames for execution of a series of encoding processes by the CODEC, while frames 35A to 35D indicate the TFO frames and the synchronization bits 36A to 36C indicate the TFO frame synchronization bit of the TFO frames 35A to 35C.

When the CODEC in the transmitting side shifts to the TFO condition from the tandem connecting condition, the PCM data transmitted from the transmitting side CODEC changes to the PCM data including the TFO frame but it is also specified that the transmitting side CODEC should transmit the TFO#TRANS message 37A just before transmission of the first TFO frame 35A. The encoding processing frame 30B can also execute, unlike the case illustrated in FIG. 5(b), the signal noise alleviation process as illustrated in FIG. 6(b) by detecting the TFO#TRANS message 37A.

In addition, since the offset value between the position of the TFO#TRANS message 37A and the position of the first TFO frame 35A is specified, the signal noise alleviation process can be executed in the course of the encoding processing frame 30B as illustrated in FIG. 6 by detecting the TFO#TRANS message 37 and considering the offset amount.

The information about the TFO#TRANS message and offset amount is transmitted to the signal noise alleviation processing section 4A by the TFO message detecting section 8A of FIG. 1. As described above, the signal noise alleviation processing section 4A performs the signal noise alleviation process on the basis of the synchronization bit information of the TFO frame detecting section 7A, the TFO#TRANS information and the offset amount information of the TFO message detecting section 8A.

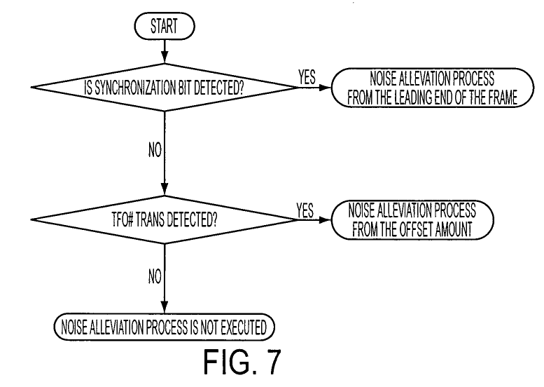

FIG. 7 illustrates a flowchart of the processing contents of the signal noise alleviation processing section 4A. When the TFO frame synchronization bit is detected from the input PCM with the TFO frame detecting section 7A as illustrated in FIG. 7, the encoding processing frame of which a synchronization bit is detected is determined as the frame of the PCM data including the TFO frame and the signal noise alleviation process is performed from the leading area of the frame of the encoding processing frame.

Moreover, when the TFO frame synchronization bit is not detected and the TFO#TRNS is detected, the TFO frame commencement position can be detected from the TFO#TRANS and offset value. Therefore, the signal noise alleviation process is executed from the TFO frame commencement position obtained from the offset amount.

When it is determined with the information from the TFO frame detecting section 7A and TFO message detecting section 8A that a TFO frame is not transmitted from the transmitting side CODEC, the signal noise alleviation processing section 4A does not perform the signal noise alleviation process.

When the local hand-over occurs as illustrated in FIG. 2, the PCM data including the TFO frame is transmitted simultaneously with commencement of a call. However, the signal noise alleviation processing section 4A detects the TFO frame synchronization bit depending on the flow of FIG. 7, performs the signal noise alleviation process from the leading area of the encoding processing frame and outputs the result to the encoding section 5A. The PCM data having completed the signal noise alleviation process encoded to the compressed code data with the encoding section 5A, output from the CODEC 13C, decoded with the CODEC in the terminal 15B, and is then output as the audio signal.

Accordingly, since the signal noise due to the TFO frame can be alleviated by using a CODEC of the present invention even when the PCM data including the TFO is input to a CODEC not in the TFO condition such as the case where the local hand-over is generated, signal noise of the audio signal output from terminal 15B can be lowered.

Next, operations when the PCM data not including the TFO frame is input, due to the local hand-over, to the CODEC in the TFO condition will be described below.

In a CODEC supporting the TFO condition, the TFO frame synchronization bit and CRC code of the encoded data or the like are specified as the error check object during TFO operation. The PCM data input to the CODEC in FIG. 1 is then input to the TFO frame detecting section 7A and TFO message detecting section 8A for the purpose of various error checks in the TFO frame detecting section 7A.

When an error is detected in the CRC code added to the encoded data by the TFO frame detecting section 7A, the encoded data is processed as a bit error and the TFO condition is shifted to the tandem connecting condition.

If the TFO frame cannot be recognized by the TFO frame detecting section 7A, the TFO message SYL is transmitted, and when four SYL messages are transmitted, reception of the TFO frame is stopped and the TFO condition is shifted to the tandem connecting condition according to the TS28.062 standard. Since three frames are used for transmission of only one SYL message, at least 12 frames (0.24 seconds) are required for transition to the tandem connecting condition.

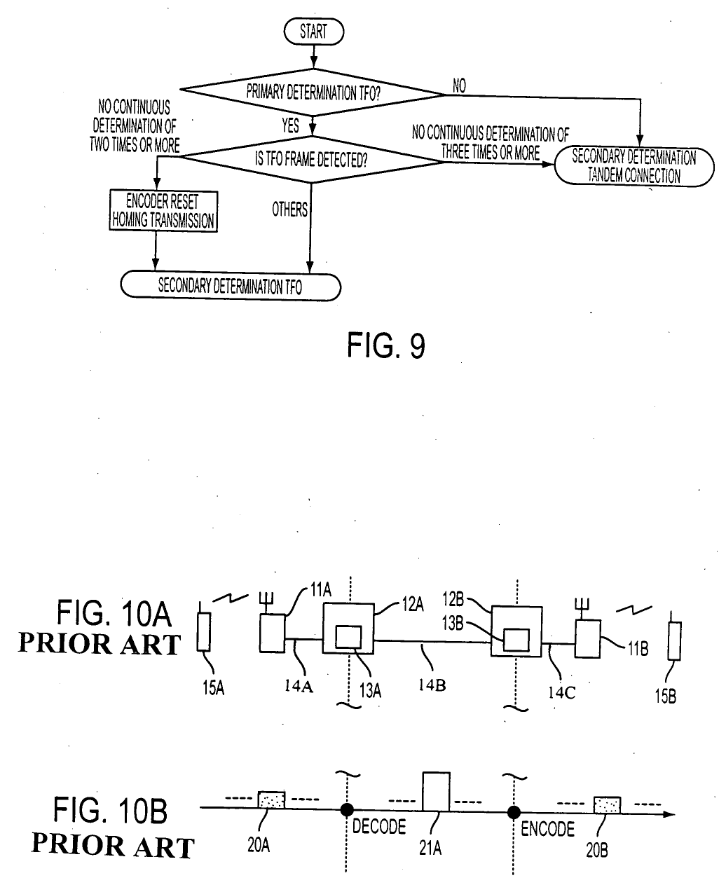

According to the TS28.062 standard, since the TFO condition is not shifted to the tandem connecting condition even when the TFO frame does not exist, a silent condition of cell loss continues. However, in a CODEC in an embodiment of the present invention, a TFO secondary determining section 10A specifies the operations thereof on the basis of information concerning the existence or no-existence of the TFO frame obtained from the TFO frame detecting section 7A and the determining information of the TFO determining section 9A which operates conforming to the TS28.062 standard. The operation determination flow of the TFO secondary determining section 10A is illustrated in FIG. 9. This operation may be implemented in software or specialized circuitry or a combination thereof.

When the TFO determining section 9A determines that the operating condition is not the TFO condition conforming to the TS28.062 standard, the TFO secondary determining section 10A also determines that the operating condition does not shift to the TFO condition but to the tandem connecting condition. When the TFO determining section 9A still determines the TFO condition, the TFO secondary determining section 10A makes a determination on the basis of information concerning the existence or no-existence of the TFO frame obtained from the TFO frame detecting section 7A.

When the TFO frame is detected only once or not detected, the TFO secondary determining section 10A determines that it operates in the TFO condition.

When the TFO frame is not detected two times continuously, the TFO determining section 9A conforming to the TS28.062 still determines the TFO condition, but the TFO secondary determining section 10A resets the encoding section 5A and also causes the compressed code data output from the encoding section 5A to output a homing signal to reset the encoder. The homing signal is a signal of the special pattern which realizes resetting of the coder or decoder of the remote area and is specified with adaptive multi-rate (AMR) as the standard CODEC of IMT-2000.

When the TFO frame is not detected continuously for three or more times, the TFO secondary determining section 10A determines to shift to the tandem connecting condition.

When the TFO secondary determining section 10A determines to shift to the tandem connecting condition from the TFO condition and also determines transmission of the homing signal, the condition quickly shifts to the tandem connecting condition from the silent condition of the cell loss in the TFO condition. Generation of noise due to mismatching of internal variables of the encoder in the transmitting and receiving sides during the shift to the tandem connecting condition from the TFO condition can be prevented with reset of the encoding section and transmission of the homing signal.

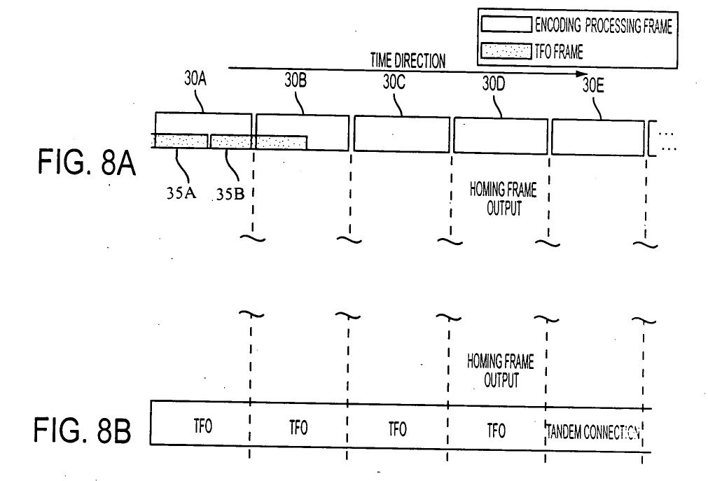

FIGS. 8(a) and 8(b) illustrate transition of the PCM data and operations of the CODEC when the PCM data including the TFO frame disappears suddenly in the source of frame in the PCM data train input to the CODEC in the TFO condition. In FIG. 8(a), the frames 30A to 30E indicate the encoding processing frames for which CODEC performs a series of the encoding processes, while the frames 35A to 35B indicate the TFO frames. In general, the encoding processing frame of the CODEC is not synchronized with the TFO frame and the TFO frame 35B appears in the source of the encoding processing frame 30A in FIG. 8(a).

In FIG. 8(a), the TFO frame disappears finally from the encoding processing frame 30B. The TFO frame detecting section 7A informs that the TFO frame is not detected for the encoding processing frame 30C and subsequent frames thereof to the TFO secondary determining section 10A.

The TFO secondary determining section 10A detects, as illustrated in the flowchart of FIG. 9, that the TFO frame is not detected twice continuously when the encoding processing frame 30D is received and outputs the homing frame. Moreover, the TFO secondary determining section 10A also detects, in the encoding processing frame 30E, that the TFO frame is not detected continuously in three times when the encoding processing frame 30E is received and then shifts to the tandem connecting condition.

Meanwhile, according to determination of a TFO condition which conforms to the TS28.06 standard, at least 12 frames are required to shift to the tandem connecting condition after disappearance of the TFO frame. Therefore, the time required to shift to the tandem connecting condition after disappearance of the TFO frame can be shortened by the introduction of the determination by the TFO secondary determining section 10A. Thereby, the homing frame can be transmitted synchronously with the shift to the tandem connecting condition.

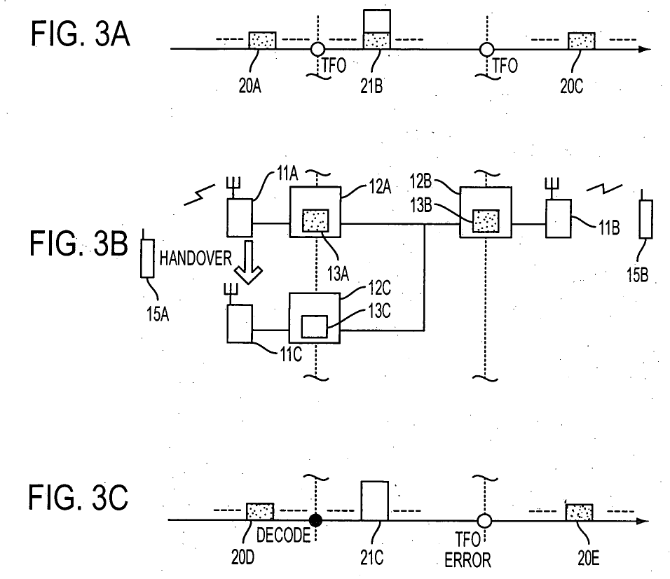

When the remote hand-over occurs as illustrated in FIG. 3, the PCM data not including the TFO frame is transmitted to CODEC 13B in the TFO condition with the CODEC 13C. However, a shift to the tandem connecting condition can be realized quickly by utilizing the TFO secondary determining section as described above. Accordingly, a reduction of a silent condition audio signal being output from the terminal 15B is achieved.

Here, the pattern of signal filling of the two least significant bits of the PCM data including the TFO data described above and illustrated in FIG. 4 can be set freely to result in minimum signal noise.

Moreover, with regard to the conditions of the determination flow of the TFO secondary determining section 10A, it is naturally possible to freely set the number of times of continuous disappearance of the TFO frame to determine the shift to the tandem connecting condition in view of assuring the smooth switching operation between the TFO condition and the tandem connecting condition.

As described above, signal noise not related to the original signal, for example, the signal noise of the two least significant bits of the PCM signal including the TFO frames can be lowered and generation of a sudden signal disappearance and an irregular level can be reduced by applying the present invention to TFO communication which can be realized by switching the communication using the data multiplexing signals of different encoding systems and the communication using the data encoded with only one encoding system.

The present invention can be applied not only to the data in which the two least significant bits of the PCM data in the TFO condition is filled with the TFO frames but also to the data of other encoding systems which are used for communication through multiplexing of the data of different encoding systems. This present invention may be implemented in software or specialized circuitry or a combination thereof.

Moreover, in this embodiment, a fixed pattern is included to reduce signal noise due to the two least significant bits of the PCM signal including the TFO frames, but when the present invention is introduced into the data of another encoding system, unwanted signal noise can be reduced by selecting and including the optimum replacement pattern with the algorithm of the other encoding system.

Next, the transmission system to which an embodiment described herein is applied will be described.

In the transmission system, an audio signal silent condition to be transmitted can be reduced and deterioration of sound quality can also be improved even during the local hand-over illustrated in FIG. 2, namely when the TFO condition does not appear (tandem connecting condition) even though the PCM data including the TFO frame is transmitted and even during the remote hand-over illustrated in FIG. 3, namely when the tandem connecting condition does not appear (TFO condition) even though the PCM data not including the TFO frame is transmitted.

According to the TS28.062 standard, if the negotiation between CODECs is not performed in the local hand-over illustrated in FIG. 2, the CODEC cannot shift to the TFO condition. Accordingly, the CODEC 13C is in the tandem connecting condition (non-TFO condition) and receives the PCM data 21C including the TFO frame as the input. When a CODEC embodiment herein is applied to the CODEC 13C, the TFO frame detecting section 7A of FIG. 1 detects the TFO frame included in the PCM data 12C and transmits the synchronization bit information to the signal noise alleviation processing section 4A. The signal noise alleviation processing section 4A performs the signal noise alleviation process as illustrated in FIG. 4 and outputs the data to the encoding section 5A. As a result, signal noise can be reduced more than that in the encoding of the PCM data including the TFO frame.

Accordingly, even when the base station of terminal 15B is handed over to the base station 11C from the base station 11B, influence of mixed signal noise through the encoding of the PCM data including the TFO frame can be alleviated in the transmission of the audio signal inputted from terminal 15A.

According to the TS28.062 standard, if negotiation between the CODECs is not performed in the remote hand-over illustrated in FIG. 3, the CODEC cannot be shifted to the TFO condition. Thereby the CODEC 13C is set to the tandem connecting condition (non-TFO condition) and the PCM data 21C not including the TFO frame is outputted. Therefore, the PCM data 21C not including the TFO frame is inputted to the CODEC 13B in the TFO condition (non-tandem connecting condition).

When the CODEC in the TFO condition has received the PCM data not including the TFO frame, the “frame-loss” error (TFO error) condition is generated, in which the TFO frame cannot be detected. When CODEC 13B is in the frame-loss condition, the audio signal output from terminal 15B by decoding the compressed code data output from CODEC 13B is set to the silent condition.

According to the TS28.062 standard, when the PCM data not including the TFO frame is input continuously, at least 12 frames (0.24 seconds) are required until the CODEC shifts to the tandem connecting condition from the TFO condition. However, according to the present invention, if the PCM data not including the TFO frame is inputted continuously in three frames, the silent condition can be shortened because the CODEC is controlled by the TFO secondary determining section 10A to shift to the tandem connecting condition.

Moreover, since the homing signal to reset the encoding section 5A and the CODEC for decoding the compressed code data output from the encoding section 5A is transmitted when the TFO condition is shifted to the tandem connecting condition, generation of signal noise due to mismatching of internal variables of CODEC when the TFO condition is shifted to the tandem connecting condition can be reduced.

Accordingly, even when the base station handling terminal 15A is handed over to base station 11C from base station 11A, the influence of a continuation of the silent condition due to the input of PCM data not including the TFO frame can be alleviated in the transmission of the audio signal input from terminal 15A.

As described above, a data processing apparatus can reduce generation of signal noise and a silent condition of the output audio signal and also reduce generation of signal noise during the shift to the tandem connecting condition from the TFO condition.

Moreover, even in the case of communication not only in the TFO condition but also the condition of using data multiplexing for data of different encoding systems, output signal noise can be lowered and generation of sudden signal disappearance and irregular level can be reduced.

The TFO information of the input PCM data is detected with the TFO frame detecting section (7A) and the TFO message detecting section (8A) and noise included in the TFO frame received in the tandem connecting condition is alleviated with the signal noise alleviation processing section (4A).

Moreover, determination of switching for the TFO condition and the tandem connecting condition is performed in two stages with the TFO determining section (9A) and the TFO secondary determining section (10A) in order to shorten the silent condition period. When TFO is switched to the tandem connection, the homing signal is transmitted to prevent generation of a noise signal due to the mismatching of internal condition variables of the CODEC for the decoding process.

In the claims:

1. A data processing method for inputting data, the input data including one of a first data and a third data, the first data formed by encoding a signal with a first encoding system, and the third data formed by multiplexing second data formed by encoding the signal with a second encoding system and said first data, the data processing method outputting fourth data, the data processing method comprising the steps of:
providing a first mode for inputting the first data, encoding the input data with the second encoding system and outputting the encoded input data as the fourth data;
providing a second mode for inputting the third data, isolating the second data and outputting the second data as the fourth data; and
providing a third mode for inputting the third data, replacing a part of the third data where the second data is multiplexed with a particular data, encoding the input data including the replaced part with the second encoding system and outputting the encoded data as the fourth data.

2. The data processing method of claim 1, further including the steps of:
determining if the input data is the first data or the third data; and
determining whether to process the input data in the second mode or the third mode when the input data is the third data.

3. The data processing method of claim 2, wherein the first encoding system includes PCM and the signal is an analog signal.

4. A data processing method for inputting data, the input data including one of a first data and a third data, the first data formed by encoding a signal with a first encoding system, and the third data formed by multiplexing second data formed by encoding the signal with a second encoding system and said first data, the data processing method outputting fourth data, the data processing method comprising the steps of:
detecting if the input data is the first data or the third data; and
determining whether to transition from a first operation mode to a second operation mode for coding the input data, wherein
when an operation mode is to be switched to said first mode or said second mode, a signal for resetting a data processor for decoding the data output with said second encoding system is added, before such switching operation, to said fourth data and is then outputted.

5. A data transmission system communicating between a first terminal transmitting second data formed by a second encoding system, and a second terminal for receiving information transmitted from the first terminal comprising;
a first data terminal for inputting said second data and outputting first data encoded with a first encoding system in a first mode and third data multiplexing said second data and said first data in a second mode; and
a second data terminal for inputting said first or third data output and outputting to the second terminal, in the first mode, fifth data formed by encoding said first data input with a second encoding system and also outputting, in the second mode, said second data isolated from said third data, wherein
when said second data terminal is in said first mode and said third data is input, a part of said third data where said second data is multiplexed is replaced with the particular data and said particular data is outputted through the encoding thereof with said second encoding system.

6. A data transmission system communicating between a first terminal transmitting second data formed by a second encoding system, and a second terminal for receiving information transmitted from the first terminal comprising;
a first data terminal for inputting said second data and outputting first data encoded with a first encoding system in a first mode, and also outputting third data multiplexing said second data and said first data in a second mode;
a second data terminal for inputting said first or third data, and outputting to said second terminal, in a first mode, fifth data formed by encoding said first data with a second encoding system and also outputting said second data isolated from said third data in a second mode, wherein
when an operation mode is to be switched to said first mode or said second mode, the data for resetting a data processor to decode the data output with said second encoding system is added to said fourth data and then output before said mode switching operation.

7. A data processing apparatus for inputting first data formed by encoding an analog signal with a first encoding system or third data multiplexing second data formed by encoding said analog signal with a second encoding system and said first data and outputting fourth data encoded with said second encoding system, comprising;
a first mode and a second mode;
a data input section for outputting whether said input data is said third data or not to an input data determining section, isolating said second data from said third data inputted when said input data is third data in a second mode and then outputting said isolated second data to an output switching section; and
a signal processing section for inputting said input data and outputting said input data to an encoding section; wherein
said output switching section outputs an output of said signal processing section in said first mode and outputs an output of said data input section in said second mode; and
said signal processing section converts, when said third data is inputted in said first mode, a part of said third data where said second data is multiplexed to the particular data and outputs said particular data to said encoding section.

8. A data processing apparatus for inputting first data formed by encoding analog signal with a first encoding system or third data multiplexing second data formed by encoding said analog signal with a second encoding system and said first data and outputting fourth data encoded with said second encoding system, comprising;
a first mode and a second mode;
a data input section for outputting whether said input data is said third data or not to an input data determining section, isolating said second data from said third data inputted when said input data is third data in the second mode, and outputting said isolated second data to an output switching section; and
a signal processing section for inputting said data inputted and outputting said input data to an encoding section; wherein
said output switching section outputs an output of said signal processing section in said first mode and outputs an output of said data input section in said second mode; and
said encoding section adds, when operation mode is to be switched to said first mode or second mode, the data for resetting a data processing apparatus for decoding the data outputted in said second encoding system to said fourth data and then outputs these data before said mode switching operation.

9. The data processing apparatus according to claim 8, wherein said input data determining section determines that said third data is inputted by detecting the synchronization bit of said multiplexed data.

10. The data processing apparatus according to claim 8, wherein said input data determining section determines that said third data is inputted by detecting the signal to be transmitted before said third data is transmitted.

11. The data processing apparatus according to claims 6, wherein the input starting position of said third data determined as input is obtained from the signal to be transmitted before said third data is transmitted.
